(19) United States
(12) Patent Application Publication
(10) Pub. No.: US 2007/0119408 A1
(43) Pub. Date: May 31, 2007

(54) Rotary machine with major and satellite rotors

(76) Inventor: Julian Zhen Chuan Kang, New South Wales (AU)

Correspondence Address: KING & SCHICKLI, PLLC, 247 NORTH BROADWAY, LEXINGTON, KY, 40507, US

(21) Appl. No.: 10/558,603

(22) PCT Filed: Jan. 30, 2004
(86) PCT No.: PCT/AU04/00112

§ 371 Date: Jan. 3, 2007

(30) Foreign Application Priority Data
Jan. 31, 2003 (AU) 2003900394
May 26, 2003 (AU) 2003902580

(51) Int. Cl. F02B 53/04; F01C 1/24

(52) U.S. Cl. 123/232; 418/196; 123/238

(57) ABSTRACT

Rotary internal combustion engine or pump (10) including a main body (11) having a void (15) with a peripheral wall (32, 34), a major rotor (14) having a first rotation axis (16), at least one outer peripheral wall (13) portion radially spaced from the axis and defining a bight (17) within the major rotor (14); one or more satellite rotors (12) disposed within the or each bight (17) for rotation about a second axis of rotation (18) which is coaxial with the central axis of the bight; one or more control chambers (80) being defined at any time during a work cycle by any combination of two or more of a wall of the or each satellite rotor (12), the peripheral wall of the void (15) and the peripheral wall of the major rotor (14). The engine also has a plurality of ports (30, 28) for permitting the flow of fluid to and from the control chamber (80).

This invention relates generally to rotary machines, and more specifically to rotary internal combustion engines, compressors, pumps, and turbines, for expandable gases or compressible liquids.

Rotary internal combustion engines are known, examples of which include the Wankel rotary engine and the Sarich orbital engine. These engines suffer from the disadvantage that they require complicated components and seals, exhibit lower compression ratios than some engines and an orbital rotary motion of the rotor which moves the centre of mass, increasing vibration, making balancing difficult.

The present invention seeks to provide a rotary machine which alleviates one or more of the aforementioned disadvantages.

According to one aspect of the present invention there is provided a rotary internal combustion engine or pump which includes: at least one main body having a void therein, the void having a peripheral wall; a major rotor member disposed within the void for rotation about a first axis of rotation, the major rotor member including at least one outer peripheral wall portion radially spaced from the rotation axis, the peripheral wall portion including at least one generally arcuate wall section defining at least one bight within the major rotor, the or each bight having a central axis; one or more satellite rotor members, the or each satellite rotor member disposed within the or each bight for rotation about a second axis of rotation which is generally coaxial with the central axis of the or each arcuate bight; one or more control chambers being defined generally at any time during a work cycle by any combination of two or more of a wall of the or each satellite rotor member, the peripheral wall of the void and the peripheral wall of the major rotor member; the engine further including a plurality of ports associated with the or each main body for permitting the flow of a fluid to or from the control chamber.

According to another aspect of the present invention there is provided a rotary engine or pump which includes: at least one main body having a void therein, the void having a peripheral wall and at least one generally arcuate wall defining at least one bight having a central axis; a major rotor member disposed within the void for rotation about a first axis of rotation, the major rotor member including a peripheral wall spaced from the rotation axis; one or more satellite rotor members, the or each satellite rotor member disposed within the or each bight for rotation about a second axis of rotation; one or more control chambers being defined generally at any time during a work cycle by any combination of two or more of a wall of the or each satellite rotor member, the peripheral wall of the void and the peripheral wall of the major rotor member; the engine further including a plurality of ports associated with the or each main body or rotor for permitting the flow of a fluid to or from the control chamber.

Preferably, the or each major rotor member is operatively connected to an output shaft via a transmission means.

In one preferred embodiment, the peripheral wall of the void is a generally trochoid, epitrochoid or cycloid shape, by which is defined one upper lobe and one lower lobe, meeting at a midpoint defining a waist. Other preferred embodiments include up to twelve lobes in the void.

In one form, at least part of the peripheral wall portion of the major rotor member is a circular shape (or part thereof) and is sized so that its peripheral wall forms a seal which at many points in the work cycle, defines a division between control chambers assisted by the or each waist.

In another form, the major rotor member is generally elliptical in shape. In this embodiment, the lobes are circular in shape so that the control chambers can vary in size to affect the fluid therein.

Preferably the major rotor member and satellite rotor member are operatively connected to each other via a gear system, and in one form the gears provide anti-clockwise rotation of the satellite rotor member preferably at one-third the rotation speed of the major rotor member when the major rotor member rotates clockwise. The relative speed of rotation of the major and satellite rotor members generally depends on the number of satellite rotor members associated with a major rotor member, whether the satellite rotor member is generally disposed within and rotating with the major rotor member or disposed generally outside the major rotor member, and/or the number of lobes associated with the void, the shape of the or each satellite rotor. In another preferred form the satellite rotor rotates at 1.25 times the angular speed of the major rotor member.

Preferably, the satellite rotor member is generally triangular in shape, wherein each side is generally concave. The degree of concavity may vary, and with greater concavities the or each satellite rotor may take on a spoked appearance. The-satellite rotor member may also include one or more seals generally at its vertices, so that the escape of working fluids from one control chamber to another is minimised.

A preferred embodiment of the rotary machine is suitable for use as an internal combustion engine, and in that embodiment, compression ignition fuels may be used, or spark ignition fuels may be used. One or more spark plugs may be used, for example trailing and leading, as is known in rotary engines (cf Wankel). In one form, three spark plugs may be used. Fuel injection systems may be utilised with the engine, wherein fuels may be injected in the phase just before ignition for maximum efficiency.

Preferably, the or each main body includes opposed spaced apart end walls to enclose the control chambers. In one preferred embodiment the end walls carry shafts about which the satellite rotors rotate. In this form the end walls rotate at the same rate as the major rotor and are affixed to the shaft thereof, but allow the satellites to rotate about the shaft to which they are affixed.

Preferably, the peripheral wall of the void is roughened slightly, as with a hone or similar tool to increase lubricant retention and to increase feedback control of the satellite rotor member when operated without gears operatively connecting the satellite and major rotor members.

Preferably, the or each main body has associated therewith two ports, one port being an inlet port and the other being an exhaust port. The inlet and exhaust ports may be disposed at one end of the cylinder in close proximity to one another. The inlet port is adapted to allow a working fluid such as air or a fuel air mixture into the control chamber at a selected part of the rotation of the rotor members. The exhaust port is adapted to allow egress of spent working fluid from the control chamber and drawn away to, for example an exhaust pipe. In one form the ports may be associated with the or each major rotor, such that each port terminates at the peripheral wall of the major rotor. In other embodiments, more ports per main body may be provided, generally in pairs of inlet and exhaust ports.

Known methods of sealing may be employed to reduce combustion or other losses, for example, gas blow-by.

Advantageously, in operation, in the case of the internal combustion engine, an explosive force provided by the igniting of the working fluid in the control chamber bears on the shaft upon which the or each satellite rotor is mounted. Generally ignition occurs once the satellite rotation axis rotates past an axis generally extending between the major rotor member's central rotation axis and the spark plug. In this case generally all torque is provided in the required direction.

According to yet another aspect of the present invention there is provided a piston element suitable for use in an internal combustion engine or pump, the piston element when in use operatively mounted disposed for rotation within a void having a cooperating interior peripheral wall, the piston element including: a plurality of working surfaces in the form of peripheral working walls; one or more peripheral link walls, each peripheral link wall connecting adjacent peripheral working walls at each end thereof; a vertex at the junction of each peripheral link wall end and peripheral working wall end; a plurality of seal elements, each seal element disposed at each vertex, so that the seal elements improve sealing with the interior peripheral wall by subtending an angle with the cooperating interior peripheral wall as close to 90° as possible.

Preferably a biasing means is provided in the form of a spring to bias the seal elements outwardly towards a cooperating wall of a chamber in which the piston element when in use is disposed. Preferably, the spring is a compression spring which provides a generally linear biasing response. In one preferred embodiment the spring is a helical compression spring.

Preferably a carriage is provided for mounting and carrying the or each seal element.

Preferably the carriage is disposed within a cooperating housing, allowing the carriage to reciprocate in a direction generally normal to the cooperating surface.

Preferably apertures are provided in the piston or rotor in order to house the seal elements. In preferred rotor embodiments the apertures are disposed at the or each vertex of the rotor, and provide a passage between the or each vertex and the cooperating housing for the carriage.

Preferably, the or each rotor member is generally triangular in shape, wherein each side is generally concave. The degree of concavity may vary, and with greater concavities the or each satellite rotor may take on a spoked appearance. In preferred embodiments of rotor, each rotor member includes two vertices at the ends of each spoke, and a seal element disposed at each vertex, to minimise the escape of working fluid past the seal elements, especially when the radius of the cooperating surface becomes small.

According to one aspect of the present invention there is provided a piston element, when in use disposed within a chamber having a side wall, the piston element including side wall sections which when in use bear against or are disposed in close proximity to the side wall of the chamber, the side walls of the piston element being biased so as to be urged towards the side walls of the chamber.

Preferably the piston element is a rotor mounted for rotation within a chamber of an internal combustion engine or pump.

Preferably a biasing means is provided in the form of a spring which provides a generally linear biasing response to the axially spaced portions. The spring may in preferred embodiments be a leaf or coil spring or one or more Belleville washers.

In preferred embodiments the adjacent, axially spaced portions are halves of the piston element, or may include a main body and one or more covers.

Preferably the side wall sections of the chamber is a side boundary of a cylinder or void in which the piston element moves.

In order to enable a clearer understanding of the invention, drawings illustrating example embodiments are attached, and in those drawings:

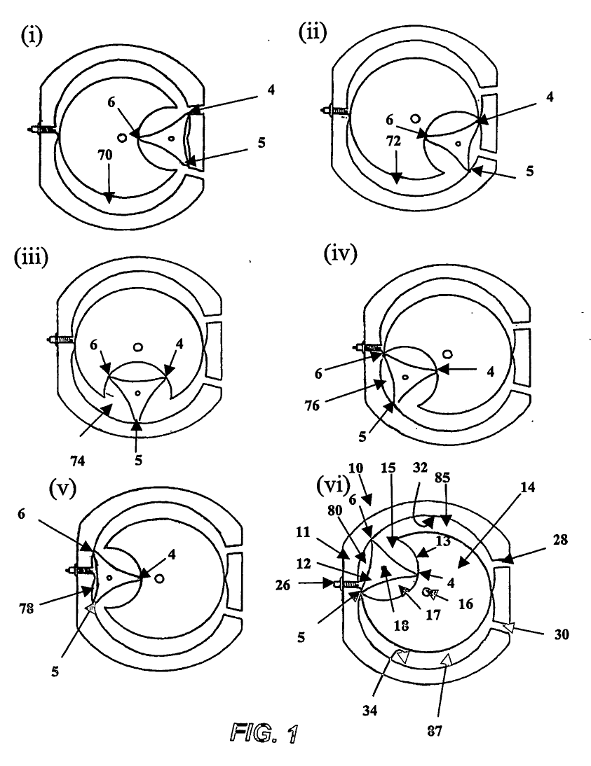

FIGS. 1(i)-(viii) shows front schematic elevation section views along a diametral plane of a rotary engine of the single satellite rotor type at various stages, in sequence, of its work cycles;

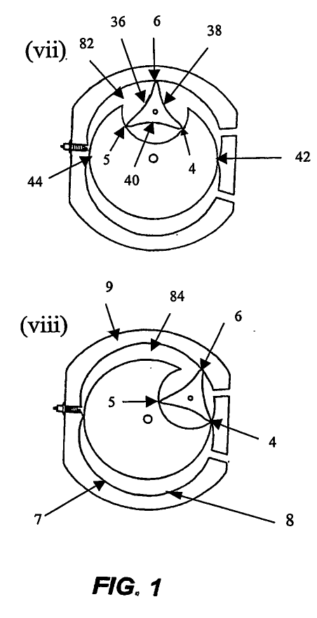

FIG. 2 shows a front schematic section elevation view along a diametral plane of a rotary engine of the twin satellite type, where a first control chamber has just commenced the ignition stage of a cycle and a second control chamber has just commenced the compression stage of a cycle;

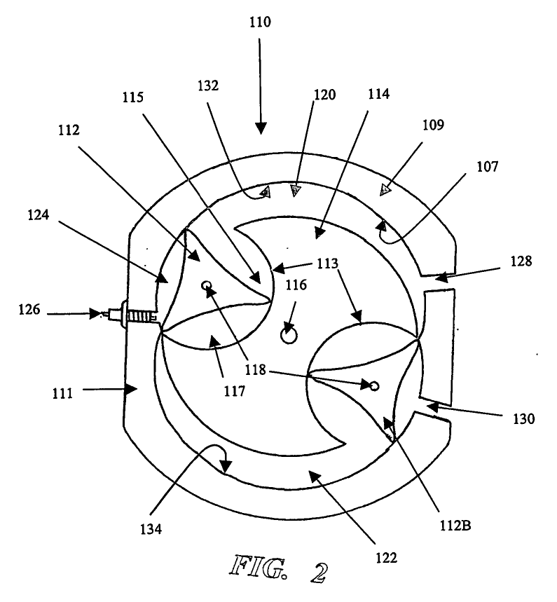

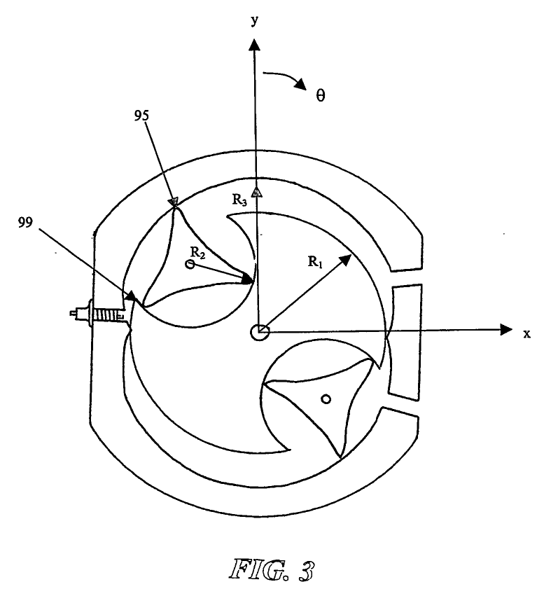

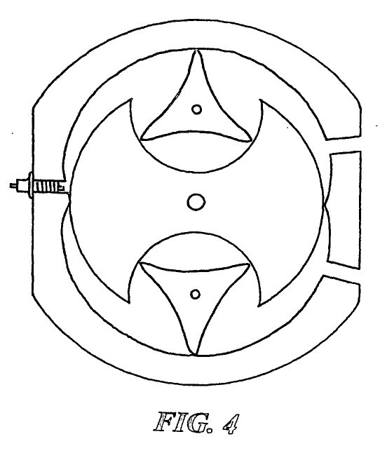

FIGS. 3 to 6 and 6A show differing schematic elevation views along a diametral plane of the same twin satellite rotor engine at differing stages around the work cycle;

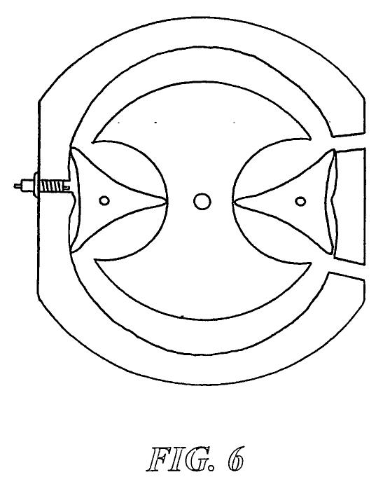

FIG. 7 shows a schematic side elevation section view showing gears and inter relationship between rotors and output shafts;

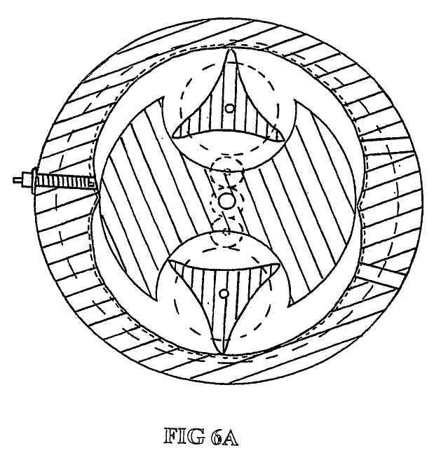

FIG. 8 shows a similar schematic side elevation section view to that shown in FIG. 7, of an engine which does not require gears to operatively connect to satellite rotors with the major rotor output shaft;

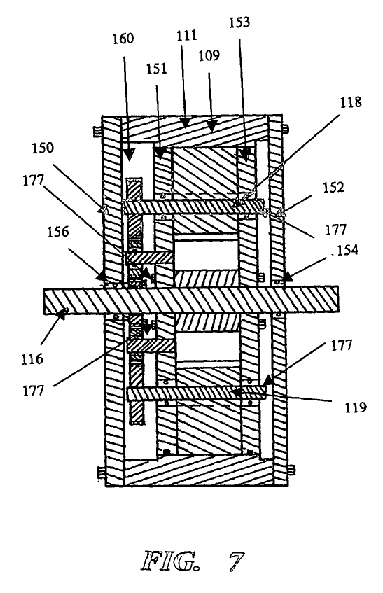

FIG. 9(i)(ii) shows plan views of satellite rotors suitable for use with an engine built in accordance with the present invention;

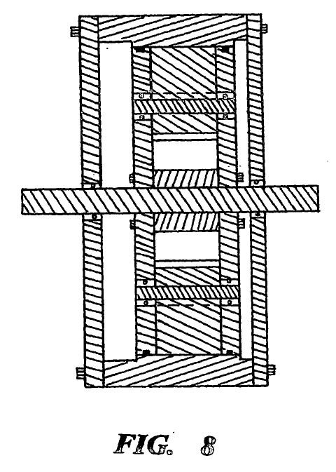

FIG. 10 shows a 12-satellite rotor engine in schematic front section elevation view;

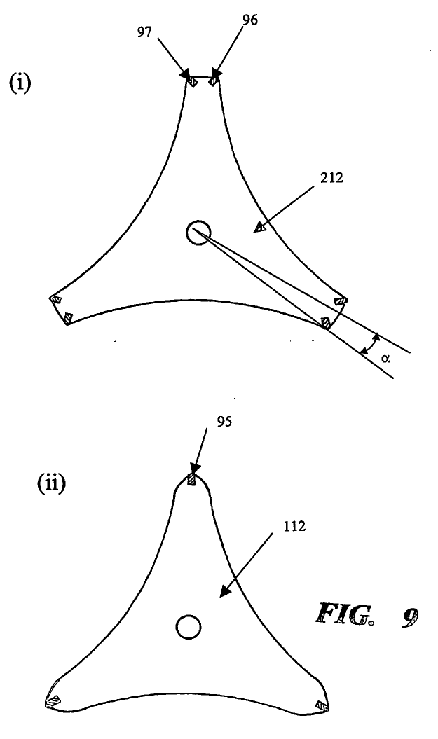

FIG. 11 shows the same embodiment as in FIG. 10, with gears (shown in hidden line script) which operatively connect the satellite rotors to the output shaft of the major rotor;

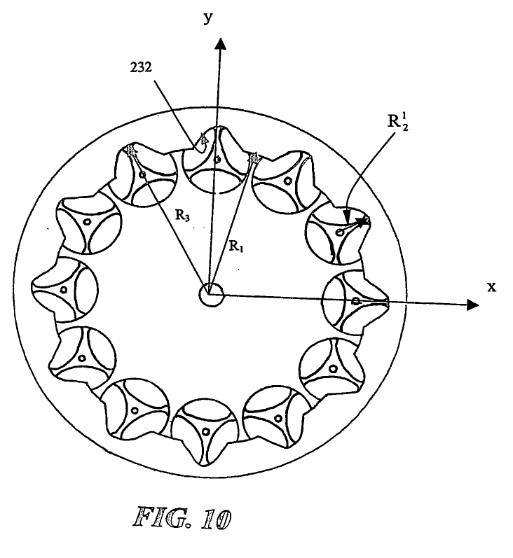

FIG. 12 shows a similar view to that shown in FIG. 10, however, with the inclusion of a spark plug and gas flow ports;

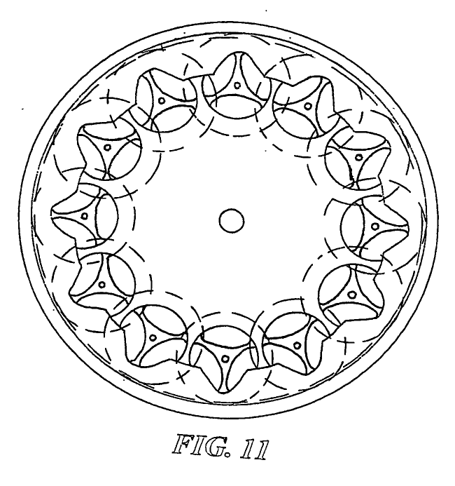

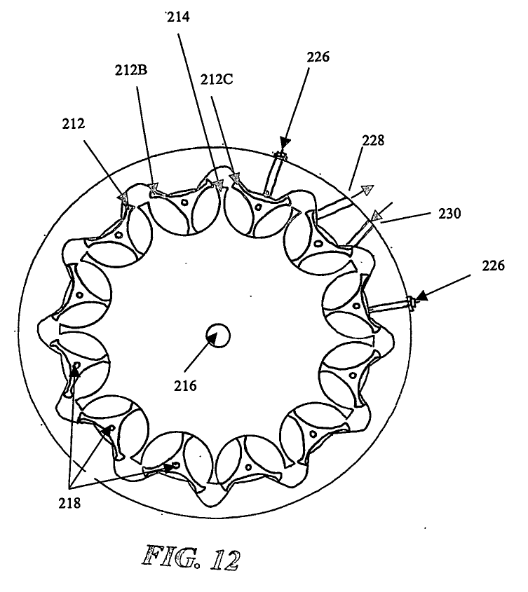

FIGS. 13 and 14 show similar views of a 12-satellite rotor engine to that shown in FIGS. 7 and 8;

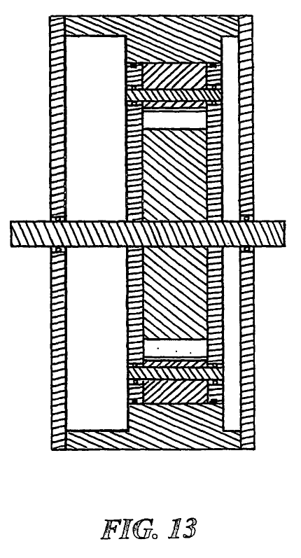

FIG. 15 shows another preferred embodiment of the invention, being a pump;

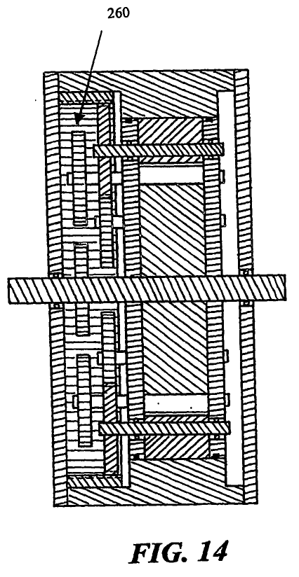

FIG. 16 shows a further preferred embodiment of a rotary internal combustion engine made according to the present invention, in schematic section elevation view along a diametral plane, the embodiment having two satellite rotors associated with one major rotor;

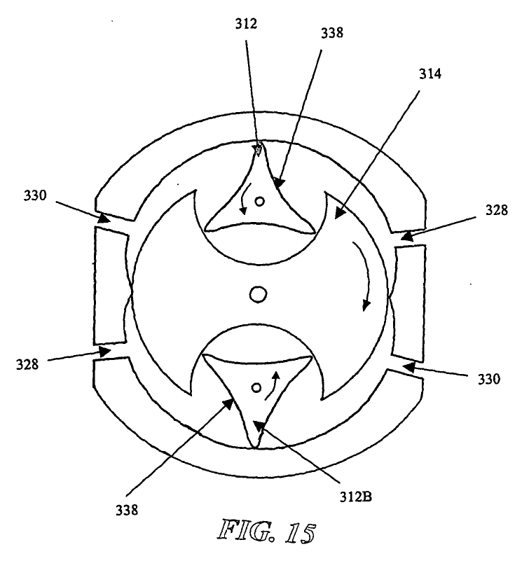

FIG. 17 is a similar view of the embodiment shown in FIG. 16, where the major rotor has advanced 90° from the previous view;

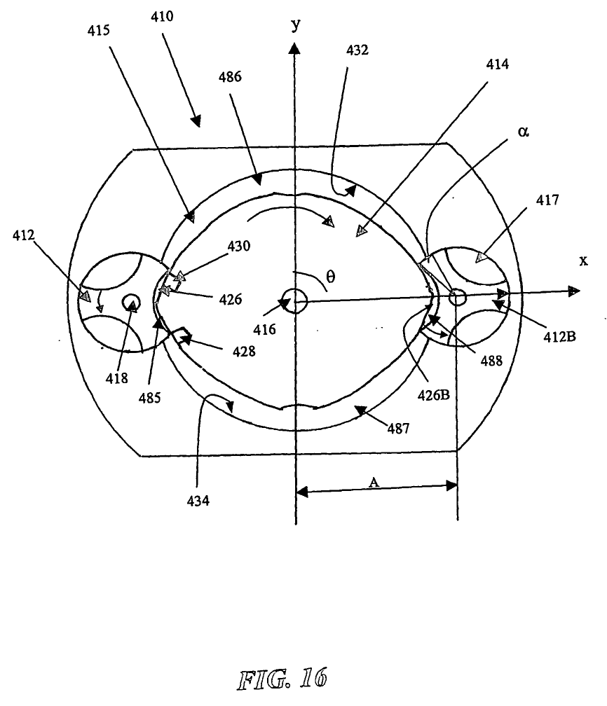

FIG. 18 is a yet further embodiment of rotary internal combustion engine (shown without inlet and exhaust ports) where one satellite rotor is at approximately the firing stage of rotation;

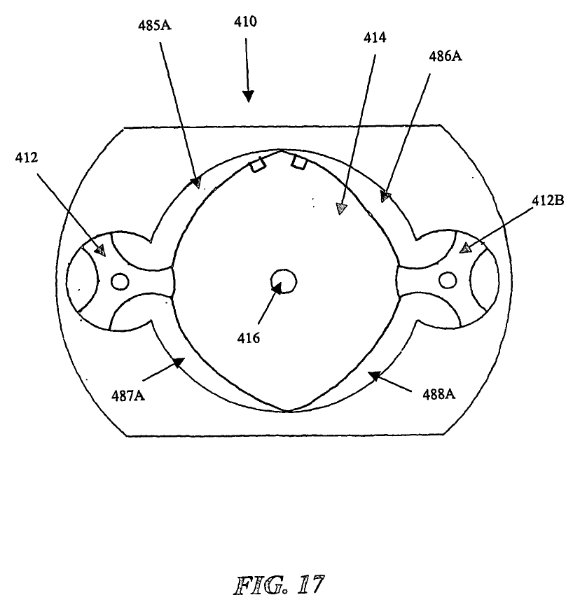

FIG. 19 is another view of the embodiment shown in FIG. 18, again shown without ports, wherein one of the rotors is positioned post-firing;

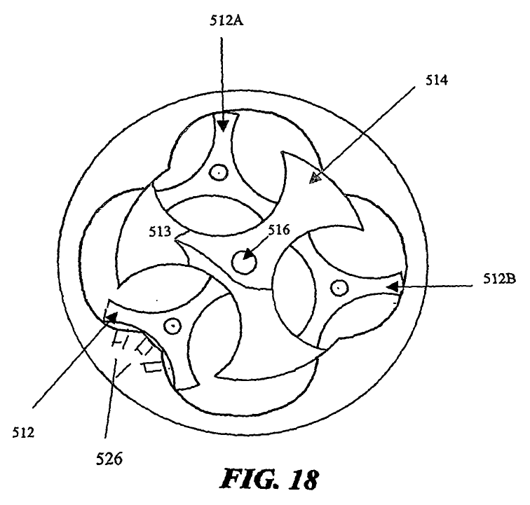

FIG. 20 is a side elevation view of a housing for use with one or more embodiments of the invention, showing the location of inlet, outlet and spark ports;

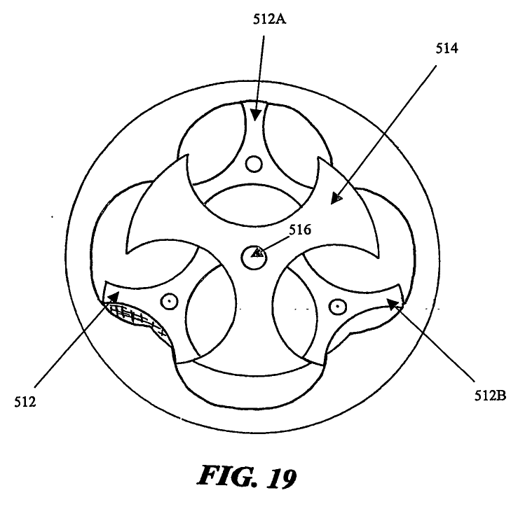

FIG. 21 is a side elevation view of a preferred embodiment of seal for insertion into a satellite rotor;

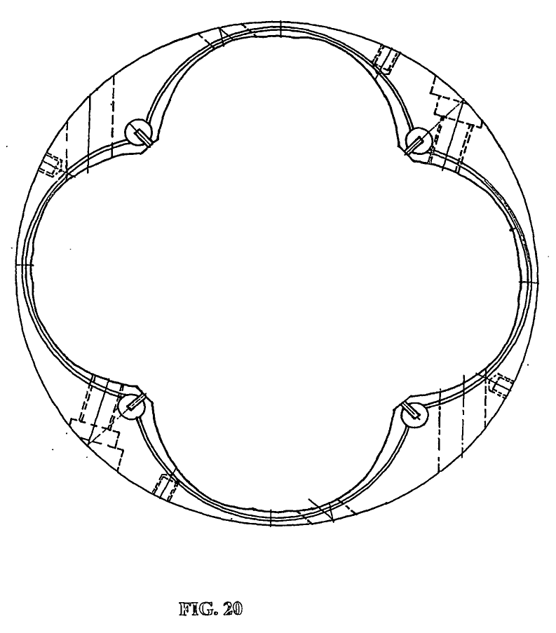

FIG. 22 is a side elevation view of a satellite rotor incorporating a seal, the seal shown in FIG. 21 and that shown in one aspect of the present invention;

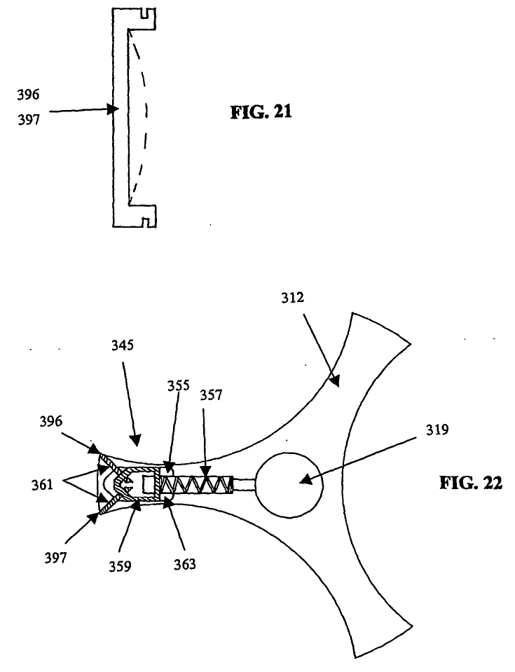

FIG. 23 is a partial axial section view of the satellite rotor shown in FIG. 22;

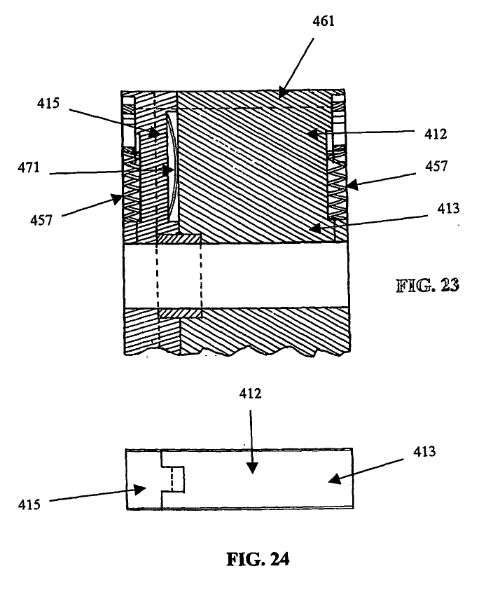

FIG. 24 is a partial top view of the satellite rotor shown in FIG. 23;

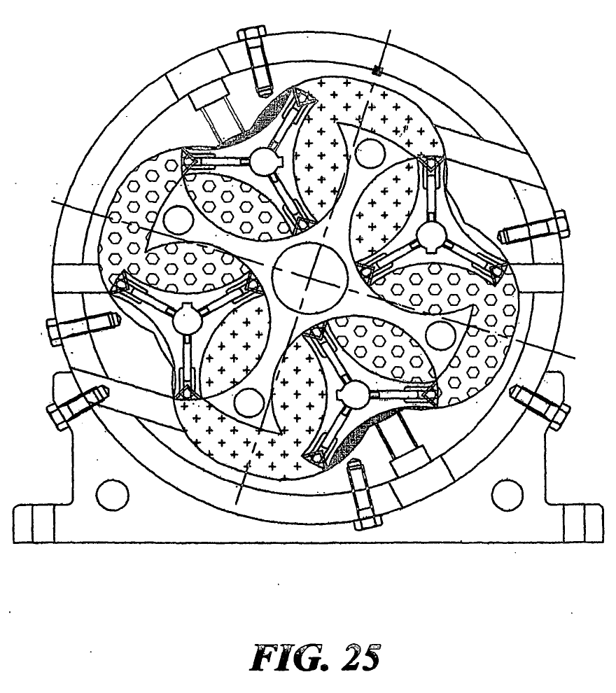

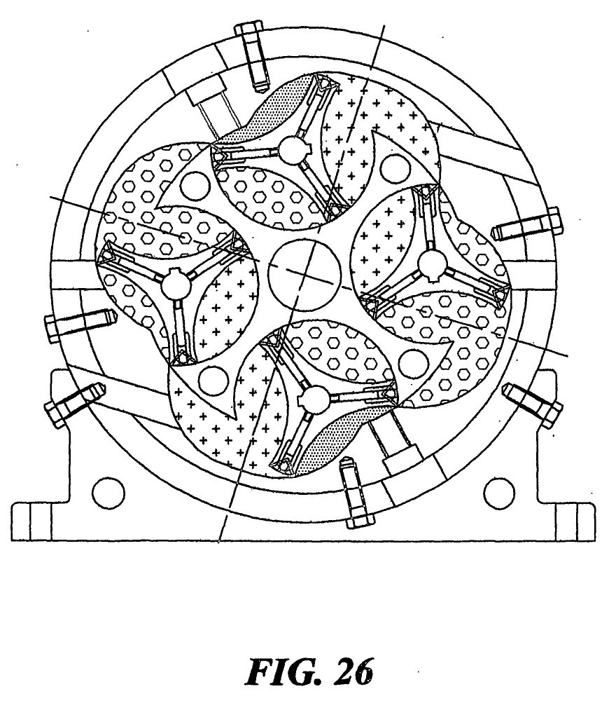

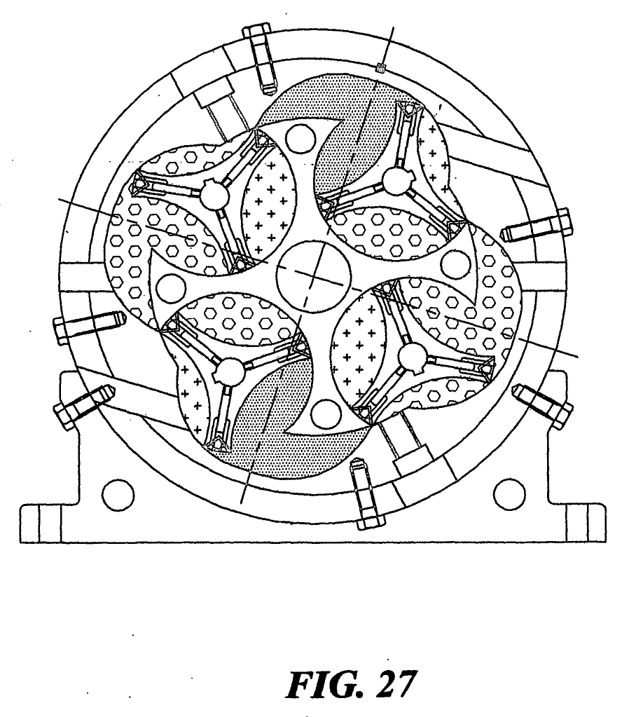

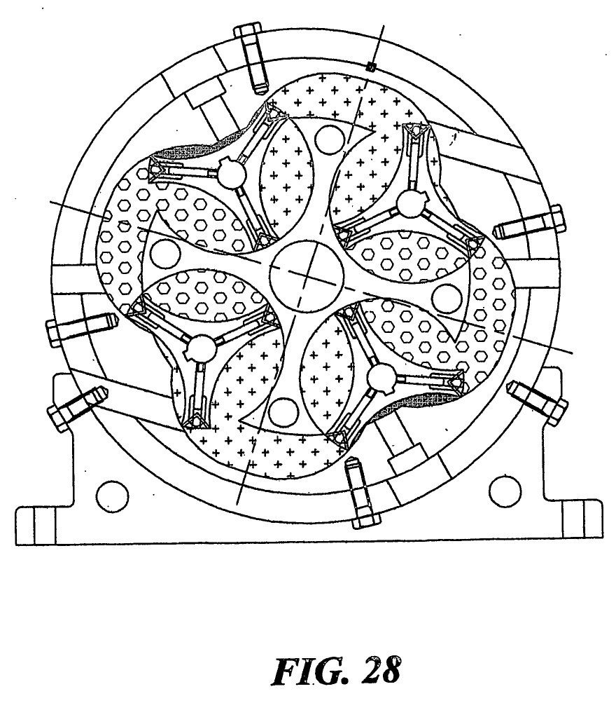

FIGS. 25-28 show a still further preferred embodiment of the invention shown in side elevation cutaway, in sequence, at different stages of the combustion cycles, wherein empty circles indicate a fresh air and/or fuel/air charge being inlet to a control chamber, crosses indicate a spent charge moving its way out towards the exhaust ports, and a closely packed pattern of dots indicates a compressed fuel/air charge undergoing a power stroke;

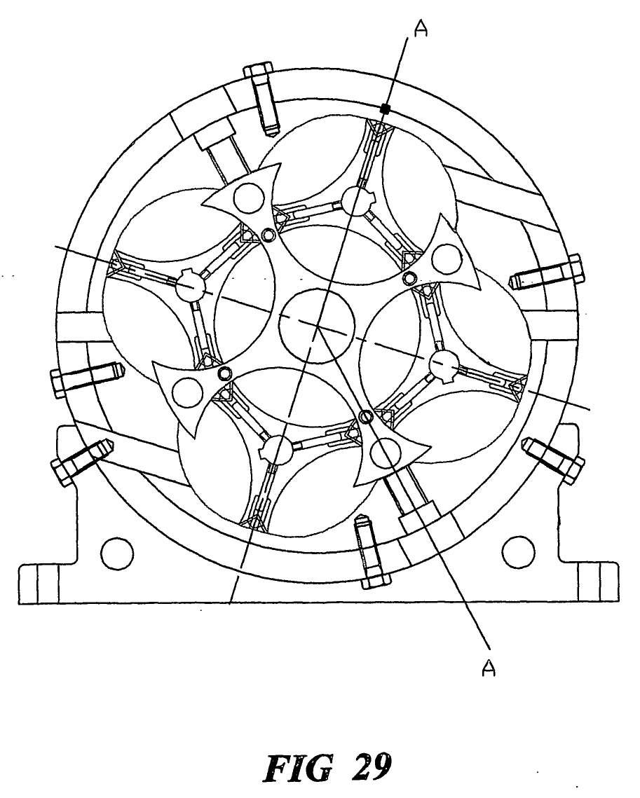

FIG. 29 is the embodiment shown in FIGS. 25-28, without the fuel/air charge and at a different angular position of the major rotor;

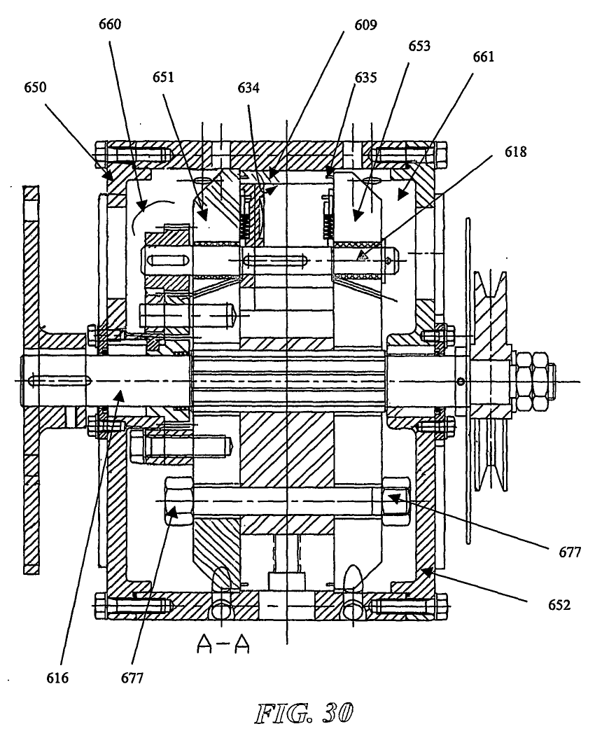

FIG. 30 is a section view of the rotary machine along A-A shown in FIG. 29.

Referring to FIG. 1 there is shown a rotary internal combustion engine generally indicated at 10 comprising an engine body 11 having a housing wall 8. The engine body 11 is in the form of a rotor block 9 containing a major rotor member 14, a satellite rotor member 12.

The rotor block is operatively connected to end plates (not shown in this embodiment but similar to 151 and 153 on a second embodiment shown in FIG. 7), the block 9 and plates 51 (151) and 53 (153) enclosing an engine body void 15. The end plates are held in place, sealed against the main body 9 by four bolts 77 (177 in FIG. 7). Furthermore, the end plates 51 (151) and 53 (153) rotate around the block 9 in unison with the major rotor 14, carrying with it the rotors 12 and 14 (or 112 and 114) via their respective axles. The satellite rotor 12 rotates at a different rate than the major rotor, and hence there is sealed slipping contact between end plates 51 and 53 and satellite rotors 12. The end plates 51 and 53 also carry shafts for a gear train (shown at 160 for a second embodiment in FIG. 7), the gear train dictating the relative rotation between satellite rotors 12 and major rotor 14.

An upper peripheral wall 32 further defines an upper lobe of the void, as well as a lower peripheral wall 34, defining a lower lobe of the void 15, and a waist 42 and 44 is disposed between the two lobes. The peripheral walls 32 and 34 define generally trochoid, epitrochoid or cycloid shapes, more particularly defined by the following mathematical equations:

Ordinate

$${y}_{a} = ( {R}_{3} - {R}_{2} ) cos θ + {R}_{2} cos ( \frac{θ}{3} )$$

Abscissa:

$${x}_{a} = ( {R}_{3} - {R}_{2} ) sin θ + {R}_{2} sin ( \frac{θ}{3} )$$

Definitions of θ, R₁, R₂ and R₃ may be found in FIG. 3, FIG. 10 and below:

θ indicates angular displacement of the rotors in a clockwise direction; starting at zero in the 12 o'clock position.

R₁ indicates the radius (distance from centre to convex circular peripheral wall) of the major rotor member

R₂ indicates the radius (distance from centre to vertex) of the or each satellite rotor member.

R₃ indicates distance from major rotor centre the inside peripheral wall of the void at θ=0.

The major rotor members 14 and satellite rotor member 12 are disposed within the void 15. The major rotor member 14 is mounted on a shaft 16. A gear train (not shown in this embodiment but similar to that shown generally at 160 in another preferred embodiment shown in FIG. 7) operatively connects the major 14 and satellite rotor members 12, in the embodiment at FIG. 1 rotating the satellite rotor member 12 at one third the rotation rate of the major rotor member 14, the two rotors having opposite-handed rotations.

The major rotor member 14 has a peripheral wall 7 which is generally circular (or circular in part) and includes a generally arcuate wall 13 which defines a bight 17 within the major rotor 14. The satellite rotor 12 is disposed for rotation at least partly within bight 17 and mounted on shaft 18.

Two ports are provided at 30 and 28 for the purpose of allowing the flow of a working fluid to 30 and from 28 the control chamber respectively. In FIG. 1, port 30 is an inlet port and port 28 is an exhaust port.

The satellite rotor member 12 is generally triangular in shape, each of the sides being generally concave. The satellite rotor member 12 has three vertices 4, 5,6 which are substantially always in sealing contact with either the inner peripheral wall of the void 32 or 34 or the periphery of the bight in which it rotates. Thus a number of separate control chambers are formed as appropriate by: the walls of the satellite rotor 36, 38 and 40 and the bight 17 walls; and the void periphery, 32, 34. Examples of the control chambers are shown at 70, 72, 74, 76, 78, 80, 82, 84, and 86. The satellites 12 are generally shaped to provide a balance between clearance with the contours of the void interior periphery 7 and a high compression ratio by providing a chamber as small as possible when at the commencement of the power stroke (generally TDC in Otto cycle parlance).

A spark plug is provided at 26 for ignition of the working fluid. Cooling is provided by apertures (not shown) in the walls of main body 9, for passage of coolant.

To describe the rotary machine in operation, we will follow a control chamber through a working cycle, stepping through FIGS. 1(i) to 1(viii) in sequence. The working cycle is based on the well-known Otto cycle of inlet, compression, power and exhaust stages.

In operation the major rotor 14 rotates clockwise about its shaft 16 and in FIG. 1(i) control chamber 70 is in fluid communication with the inlet port 30, and a working fluid is being drawn and/or forced into the control chamber 70 through the inlet port 30. The satellite rotor member 12 rotates anticlockwise about its shaft 18, and by the position shown in FIG. 1(ii), the vertex at 5 has closed off the inlet port to the control chamber, now denoted by 72, the control chamber is not in fluid communication with the inlet port 30 and the compression cycle has commenced for this chamber.

Advantageously, in operation, in the case of the internal combustion engine, an explosive force provided by the igniting of the working fluid in the control chamber bears on the shaft upon which the or each satellite rotor is mounted. Generally ignition occurs once the satellite rotation axis rotates past an axis generally extending between the major rotor member's central rotation axis and the spark plug. In this case generally all torque is provided in the required direction.

FIG. 1(iii) shows the compression cycle in a more advanced state, at FIG. 1(iv) shows it nearly complete. FIG. 1(v) shows the compression cycle complete, and the control chamber, now denoted by numeral 78, assumes its smallest volume of the work cycle.

FIG. 1(vi) shows the initial portion of the work cycle, where the power portion of the work cycle commences. This is where the spark plug 26 ignites the working fluid.

FIGS. 1(vii) and 1(viii) show the power cycle more and more advanced, until finally, we return to FIG. 1(i) where the control chamber, now denoted by numeral 86, is in fluid communication with the exhaust port 28, the power cycle ceases and the exhaust cycle begins.

Advantageously, the triangular shape of the satellite rotor allows only fresh air/charge to mix with fresh air/charge, and does not dump fuel/air charge or fresh air into the exhaust outlet. Similarly with spent charge—only spent charge within a control chamber will mix with spent charges or be dumped straight to the exhaust outlet port. This becomes particularly effective and advantageous in multi-satellite embodiments, when the interactions are complex.

Other features of the triangular satellite rotor member are that one chamber defined by walls of the satellite always undergoes a storage function. That is, only two of the chambers defined by the satellite are undergoing part of the Otto cycle. The other chamber is undergoing storage. However, as mentioned, when the storage chamber rejoins the Otto cycle, the spent and fresh charges do not mix, even to go down the exhaust, (or arguably worse, to send a spent charge back into the inlet). Similar advantages are gained by using a pentagonal-shaped satellite rotor (not shown).

More space in the engine block may be utilised than that utilised by other rotary engines. This allows higher compression ratios and greater working volumes to be used.

As will be noted by an examination of the geometry of the machine, in this first embodiment, there is provided one power cycle per rotation of the major rotor member, and thus the satellite rotor 12 rotates around the major rotor member ⅓ of a rotation per rotation of the major rotor member. However, numerals on the satellite rotor member are only valid for a single sequential reading of the cycle from 1(i) to 1(viii) thus the reader should not “loop” the cycle from 1(viii) to 1(i) because the vertices 4, 5 and 6 index around the rotor at each completion of a single major rotor member 14 rotation. It can be seen that an “empty” chamber rotates around the main body 9, doing no work on the fluid.

Referring to FIGS. 2 to 8 there is shown a rotary machine according to another embodiment of the invention, a twin satellite engine. Like features of the embodiments of those described in the first embodiment are denoted by like numerals. The embodiment in these latter Figures has two satellite rotor members, 112 and 112B, providing two power cycles per rotation of the major rotor member 114, providing greater potential for balance and efficiency. Similarly to the first embodiments, the satellite rotors 112 and 112B rotate ⅓ revolution for every single rotation of the major rotor member 114. The rotation of the satellites 112 and 112B is governed by gear trains shown at 160 in FIG. 7.

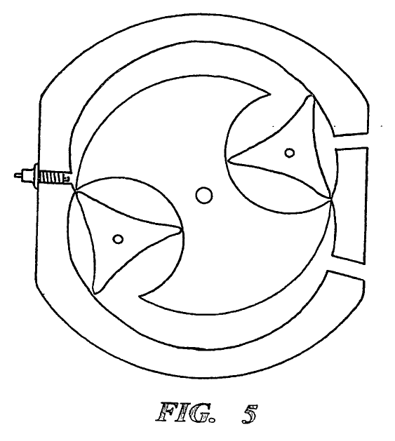

FIG. 6A shows the elevation section schematic view, of a second embodiment, showing in dashed script, gearing which operatively connects the satellite rotor members to the major rotor member. However, another embodiment shown in FIG. 8, is a rotary machine having no gears (previously shown at 160 in FIG. 7) linking the rotation of the satellite with the major rotor member 114. By the concept of advanced feedback, it is believed that the satellites 112 and 112B will not necessarily require gears to link their rotation to that of the major rotor member 114. This is because the pressure across one face of the satellite which forms part of a control chamber undergoing a power cycle (eg. 180 in FIG. 2), will be generally constant thus not allowing rotation more or less than that which would normally occur when being governed by gears 160. That is, if any combusted (or other) gas attempts to flow outwards from the control chamber for example between a seal (95, 96 or 97) and the peripheral wall 132, it will be restricted because there will be no inward flow from any other orifice (eg. the seal/major rotor interface at 99 to replace the flow). This advanced feedback system thus created is enhanced by the roughening or honing of the peripheral wall of the void 132 and 134. Thus, the mass, cost and complexity of the rotary machine will be significantly reduced by removing the gear train 160.

FIG. 9(i) shows a detail view of a satellite rotor member suitable for use with a 12 satellite rotary machine as shown in FIGS. 10 to 14. The satellite rotor 212 has generally three working sides, and is generally triangular in shape. However its vertices are flattened out and thus form snub- or squared ends, instead of points, and at each squared vertex is disposed a seal 96, 97. Advantageously, this snub-satellite can increase the sealing angle subtended by the seal and void wall, to create a better seal.

FIG. 9(ii) shows a satellite rotor member suitable for use with a 1- or 2-satellite rotary machine, generally triangular in shape, having three seals generally disposed thereon, one at each vertex.

FIGS. 10 to 14 show a 12-rotor embodiment of a machine according to the present invention, like features being are denoted by like numerals in those embodiments previously described.

The peripheral wall comprises 12 lobes 232 which are defined by the following mathematical equations on a Cartesian plane:
y_{α}=R cos θ+R₂¹ cos(α−3θ)
x_{α}=R sin θ+R₂¹ sin(α−3θ)

where: α is defined in FIG. 9(i), and in this embodiment is 0.0873 rad.
R=R₃−R₂ (R₂ and R₃ previously defined).

Whereas the previous embodiments (FIGS. 1-8) exhibited power cycles which utilised approximately 180° of major rotor member 114 rotation, the present embodiment's power cycle utilises only approximately 30° of major rotor member 214 rotation for a full power stage. Advantageously, however there are six power stages occurring simultaneously, and each satellite rotor member powers six times per rotation of the major rotor member 214, leading to smoother power delivery than other embodiments.

Section end elevation views of the rotary engine according to the 12-rotor embodiment are shown in FIGS. 13 to 14. FIG. 13 shows the section view without the gear train, the system relying on advanced feedback outlined above for rotation of the satellite rotors, and FIG. 14 showing gears 260 and ring gears.

A further embodiment of the rotary machine is shown at FIG. 15 and takes the form of a pump. In order to force fluid from the inlet port 330 to the outlet port 328, the major rotor is driven clockwise by a power source (not shown) and the satellite rotors 312 and 312B utilise the downstream face 338 to force the fluid into the outlet port 328. Pipe work (not shown) directs fluid to desired locations from port 328.

Yet another form of the invention is shown in FIG. 16. In this embodiment, the main rotor 414 is generally elliptical in shape, its peripheral wall defined by the following:

$$y = A cos θ + {R}_{2} cos ( π + α + \frac{5}{3} θ )$$

$$x = A sin θ + {R}_{2} sin ( π + α + \frac{5}{3} θ )$$

where A is defined in FIG. 16 and α is as defined in FIG. 9.

In this form, the peripheral wall 432 and 434 of the void 415 is generally circular, and similarly the walls of the bights 417 are circular, or part thereof. This embodiment further has two satellite rotor members 412 and 412B, associated with the main rotor 414.

In operation the major rotor 414 is, say, rotating clockwise, and the satellite rotors 412 and 412B thus rotate anticlockwise at ⅓ the rotation rate of the major rotor. Four control chambers are formed at all times in the work cycle of the engine. In the view shown in FIG. 16, two chambers, 485 and 488 are assuming their smallest possible volume. The working fluid in 488 is about to be, or is, ignited by spark plug 426B mounted in side plate (not shown). Chamber 487 is virtually at the end of the inlet stage, and is still in fluid communication with the inlet port 428. Chamber 485 is virtually at the completion of the exhaust stage, and is in fluid communication with exhaust port 430. Chamber 486 is virtually at the end of a power stage.

FIG. 17 shows each chamber at a later stage than shown in FIG. 16, each chamber now denoted by its FIG. 16 number followed by an “A”. As will be seen from the Figure, chamber 487A is in compression stage, 488A is in power stage, 485A is in inlet stage and 486A is in exhaust stage.

As will be noted, this latter embodiment shown in FIGS. 16 and 17 has two power strokes for every rotation of the major rotor member 414, made possible in part by the rotating ports 428 and 430 and two spaced-apart spark plugs 426 and 426B.

The embodiment shown in FIGS. 18 and 19 is of a triple-satellite engine or pump according to another preferred embodiment of the invention, the engine including four lobes within the main void. Again, like numerals denote like parts in relation to the other engine or pump embodiments described herein. In addition, operation is similar to that of the other engine or pump embodiments.

FIGS. 25-29 show yet another preferred embodiment of the invention, being an engine or pump having four satellite rotors and four lobes within the main void. Operation and structure are similar to other engine or pump embodiments described herein, and like numerals denote like parts. Satellite rotors in this embodiment rotate at 1 and ⅓ times the angular speed of the major rotor.

Referring to FIG. 22 there is shown a piston element having a seal assembly generally indicated at 345 suitable for use with a rotary engine or pump as described above. The seal assembly 345 is mounted on a satellite rotor 312 generally as described above, the satellite rotor 312 having a generally triangular main body. The main body has three major walls which are concave, the degree of concavity being such that the satellite rotor.312 takes on a spoked appearance. A seal assembly is disposed within each spoke.

The satellite rotor element 312 rotates about its central axis 319 and each spoke on the rotor 312 generally has two vertices, and a seal element disposed within a respective aperture, each aperture itself disposed at each vertex. At least one seal element maintains sealed contact with cooperating walls (not shown in this Figure, but the walls are as above described, such as for example, void periphery 32, 34, and bight periphery 13 and like variants) to define a control chamber (also not shown in this Figure).

Two vertices per spoke are generally used in order to maintain sealed contact between rotor and cooperating wall when radii of cooperating walls becomes small. However, satellite rotors with one vertex per spoke may be utilised with this seal assembly. The two-vertex system has sealing advantages over a single-vertex seal when radii become small, because the angle between the plane of the seal and the plane of the cooperating wall may be maintained in a range above approximately 30°. When seal angles fall below approximately this figure, sealing becomes ineffective. 90° between seal and wall is the ideal angle for sealing, however, with this style of rotary engine the sealing angles vary around the work cycle.

The seal assembly 345 includes a pair of seal elements 347, 349 mounted to a carriage 359, the carriage 359 mounted within a housing 363 for reciprocation along a respective spoke. The carriage 359 is operatively connected to a biasing means 355 in the form of a helical compression spring 357. This is so that the seal elements 396, 397 are biased outwards to extend from the apertures 361 in the vertices of their respective spoke to maintain sealing contact with the corresponding wall throughout a range of seal element 396, 397 wear.

Referring to FIG. 23 there is shown a section view in side elevation of a rotor element 412, the rotor element having a main body including two portions 413 and 415, each portion adjacent one another, but spaced axially along a shaft 418 about which it rotates. Disposed between the two portions 413 and 415 is a biasing means 471 in the form of a leaf spring. In this manner, end faces of the rotor may sealingly engage with side walls of an engine in which the rotor is disposed, the rotor end walls maintaining sealing engagement with the side walls of the engine notwithstanding thermal expansion or contraction of the engine.

Referring to FIG. 30 there is shown a preferred embodiment of an internal combustion engine, similar to other previously described preferred embodiments, with the same number of satellite rotors 612 and a major rotor cooperating therewith. The FIG. 30 shows side walls 651 and 653 which, along with void peripheral wall 634, enclose a plurality of control chambers. The side walls 651 and 653 are mounted to major rotor shaft 616 and rotate therewith. The side walls 651 and 653 are held together by, in this embodiment, four bolts, one of which is shown at 677 each bolt passing through cooperating holes in major rotor 614. (When there are twelve “cylinders” there are twelve bolts). In this way, axles 618 which support the satellite rotors 612 are mounted to the side walls 651 and 653 and maintain the satellite rotors on their orbit, their own rotation about their own axis 618 being spaced from the major rotor's axis of rotation 616.

The side walls 651 and 653 are sealably connected to rotor block 609 by seals 635, and when in operation, rotate past rotor block 609. In this manner, the engine housing, including end walls 650 and 652 is stationary, and may be bolted to known engine mounts, while the actual work is being performed inside the motor block, with the side 651 and 653 walls rotating with the major rotor and shaft, the satellite rotors rotating about their own axis 618 as well as orbiting about the major rotor's axis 616. Gear train 660 also rotates with side walls 651 and 653.

A sump is provided at 660 and 661 to provide lubrication and cooling. Water and/or oil may be used for cooling. A pump is utilised to draw oil from the sump and spray oil from the general area of the end walls 650 and 652 onto the rotating side walls 651 and 653 and gears 660 for cooling and lubrication.

Finally, it is to be understood that various alterations, modifications and/or additions may be incorporated into the various constructions and arrangements of parts without departing from the spirit or ambit of the invention.

1-54. (canceled)

55. A rotary internal combustion engine or pump comprising:
at least one main body having a void therein, the void having a peripheral wall;
a major rotor member disposed within the void for rotation about a first axis of rotation, the major rotor member including at least one outer peripheral wall portion radially spaced from the first axis of rotation, the peripheral wall portion including at least one generally arcuate wall section defining at least on bight within the major rotor, the at least one bight having a central axis;
at least one satellite rotor members, the at least one satellite rotor member disposed within the at least one bight for rotation about a second axis of rotation which is generally coaxial with the central axis of the at least one bight;
at least one control chamber being defined generally at any time during a work cycle by any combination of two or more of a wall of the at least one satellite rotor member, the peripheral wall of the void and the peripheral wall of the major rotor member; and
a plurality of ports associated with the at least one main body for permitting the flow of a fluid to or from the control chamber.

56. A rotary engine or pump comprising:
at least one main body having a void therein, the void having a peripheral wall and at least one generally arcuate wall defining at least one bight having a central axis; a major rotor member disposed within the void for rotation about a first axis of rotation, the major rotor member including a peripheral wall spaced from the first axis of rotation;
at least one satellite rotor members, the at least one satellite rotor member disposed within the at least one bight for rotation about a second axis of rotation;
at least one control chamber being defined generally at any time during a work cycle by any combination of two or more of a wall of the at least one satellite rotor member, the peripheral wall of the void and the peripheral wall of the major rotor member; and
a plurality of ports associated with the at least one main body or major rotor for permitting the flow of a fluid to or from the control chamber.

57. A rotary engine or pump according to claim 55, wherein the first axis of rotation is generally coaxial with a void central axis.

58. A rotary engine or pump according to claim 55, wherein in the case of an internal combustion engine the at least one major rotor member is operatively connected to an output shaft via a transmission means.

59. A rotary engine or pump according to claim 55, wherein in the case of a pump the at least one major rotor member is operatively connected to an input shaft via a transmission means.

60. A rotary engine or pump according to claim 55, wherein portions of the peripheral wall of the void are generally trochoid, epitrochoid or cycloid in shape, and at least one upper lobe and at least one lower lobe is defined, with at least one waist therebetween.

61. A rotary engine or pump according to claim 60, wherein at least part of the peripheral wall portion of the major rotor member is a circular shape or circular arc and is sized so that the peripheral wall portion at certain time in the rotation of the major rotor member forms a seal which, at those times, defines a division between control chambers assisted by the at least one waist.

62. A rotary engine or pump according to claim 55, wherein the major rotor member is generally elliptical in shape.

63. A rotary engine or pump according to claim 55, wherein the at least one satellite rotor member, the major rotor member and the void define a plurality of control chambers throughout the work cycle, by maintaining abutting adjacent walls and/or vertices.

64. A rotary engine or pump according to claim 55, wherein the major rotor member and at least one satellite rotor member are operatively connected to each other via a gear system.

65. A rotary engine or pump according to claim 55, wherein a relative speed of rotation of the major and satellite rotor members generally depends on at least one of a number of satellite rotor members associated with a major rotor member and the number of lobes associated with the void.

66. A rotary engine or pump according to claim 64, wherein the gears provide counter-clockwise rotation of the at least one satellite rotor member at one-third the rotation speed of the major rotor member when the major rotor member rotates clockwise.

67. A rotary engine or pump according to claim 64, wherein the gears provide counter-clockwise rotation of the at least one satellite rotor member at 1 and ⅓ times the rotation speed of the major rotor member when the major rotor member rotates clockwise.

68. A rotary engine or pump according to claim 55, wherein the at least one satellite rotor member is generally triangular or pentagonal in shape.

69. A rotary engine or pump according to claim 55, wherein the at least one satellite rotor member has working surfaces which are generally concave.

70. A rotary engine or pump according to claim 69, wherein the working surfaces are concave to such a degree that the at least one satellite rotor member takes on a spoked appearance.

71. A rotary engine or pump according to claim 55, wherein the at least one satellite rotor member includes vertices, and includes one or more seals generally at its vertices, so escape of the fluid from one control chamber to another is minimized.

72. A rotary engine according to claim 55, wherein the fluid is a working fluid including compression ignition or spark ignition fuels.

73. A rotary engine according to claim 55, wherein one or more spark plugs are used.

74. A rotary engine or pump according to claim 55, wherein fuel injection systems are utilized whereby fuels may be injected in the control chamber just before ignition for high efficiency.

75. A rotary engine or pump according to claim 55, wherein the at least one main body includes opposed spaced apart end walls.

76. A rotary engine or pump according to claim 55, wherein the peripheral wall of the void is roughened slightly to increase lubricant retention and to increase effectiveness or feedback control of the at least one satellite rotor member when the engine or pump is operated without gears operatively connecting the at least one satellite rotor member and the major rotor member.

77. A rotary engine or pump according to claim 55, wherein the at least one main body has associated therewith an inlet port and an outlet port.

78. A rotary engine or pump according to claim 77, wherein the inlet and outlet ports are disposed at one side of the main body in close proximity to one another.

79. A rotary engine or pump according to claim 77, wherein the inlet port is adapted to allow a working fluid such as air or a fuel/air mixture into the control chamber at a selected part of the rotation of the rotor members.

80. A rotary engine or pump according to claim 55, wherein at least one port is provided which is associated with the major rotor, such that the at least one port terminates at the peripheral wall of the major rotor and is in fluid communication with pipework to carry working fluid to and/or from the engine or pump.

81. A rotary engine or pump according to claim 80, wherein more ports per main body may be provided, generally in pairs of inlet and exhaust ports.

82. A rotary engine or pump according to claim 55, wherein a main body having side walls is provided to enclose a plurality of control chambers, the side walls rotating relative to the main body.

83. A rotary engine or pump according to claim 55, wherein the at least one satellite rotor member is mounted on an axle, the axle is mounted to side walls allowing rotation relative thereto, and the side walls are mounted to a major axle which itself is disposed for rotation with the at least one satellite rotor members and walls.

84. A rotary engine or pump according to claim 83, wherein the side walls are fixed to the major rotor member.

85. A piston element suitable for use in an internal combustion engine or pump, the piston element when in use operatively mounted disposed for rotation within a void having a cooperating interior peripheral wall, the piston element including:
a plurality of working surfaces in the form of peripheral working walls;
one or more peripheral link walls, each peripheral link wall connecting adjacent peripheral working walls at each end thereof;
a vertex at the junction of each peripheral link wall end and peripheral working wall end;
a plurality of seal elements, each seal element disposed at each vertex, so that the seal elements improve sealing by subtending an angle with the cooperating interior peripheral wall at substantially 90°.

86. A piston element according to claim 85, wherein the piston element is a rotor for use in a rotary internal combustion engine or pump.

87. A piston element according to claim 85, wherein the plurality of seal elements are generally disposed at an angle which bisects an angle subtended at each vortex by adjacent walls.

88. A piston element according to claims 85, wherein a biasing means is provided to bias the plurality of seal elements towards the cooperating surface so that an effective seal is maintained between the piston element and the cooperating surface throughout an extended range of seal element wear.

89. A piston element according to claim 88, wherein the biasing means is a spring.

90. A piston element according to claim 89, wherein the spring is a compression spring which provides a generally linear biasing response to the seal elements.

91. A piston element according to claim 89, wherein the spring is a helical compression spring.

92. A piston element according to claim 85, wherein a carriage is provided for mounting and carrying the plurality of seal elements.

93. A piston element according to claim 92, wherein the carriage is disposed within a cooperating housing allowing the carriage to reciprocate in a direction generally normal to the cooperating surface.

94. A piston element according to claim 85, wherein apertures are provided in the piston element in order to house the seal elements.

95. A piston element according to claim 94, wherein the apertures are disposed on a rotor having a plurality of vertices at its ends and provide a passage between each vertex and the cooperating housing for the carriage.

96. A piston element according to claim 85, wherein the piston element is generally triangular or pentagonal in shape, each side being generally concave.

97. A piston element according to claim 86, wherein the rotor member takes on a spoked appearance.

98. A piston element according to claim 97, wherein the rotor member includes two vertices at the respective ends of each spoke, and a seal element is disposed at each vertex, to minimize the escape of a working fluid past the seal elements, especially when the radius of the cooperating surface becomes small.

99. A piston element, when in use disposed within a chamber having a side wall, the piston element including side wall sections which when in use bear against or are disposed in close proximity to the side wall of the chamber, the side walls of the piston element being biased so as to be urged towards the side walls of the chamber.

100. A piston element according to claim 99, wherein the piston element is a rotor for use in a rotary internal combustion engine or pump.

101. A piston element according to claim 99, wherein a biasing means is provided in the form of a spring which provides a generally linear urging of the piston's side walls towards the side walls of the chamber.

102. A piston element according to claim 101, wherein the spring is a leaf spring, coil spring or Belleville washer assembly.

103. A piston element according to claim 101, wherein the piston element includes a main body formed in two adjacent, axially spaced portions which are halves of the piston or rotor.

104. A piston element according to claim 101, wherein the piston element includes a main body and one or more covers, biased apart, when in use towards side walls of a chamber.

105. A piston element according to claim 101, wherein the side wall of the chamber is a side boundary of a cylinder or void in which the piston reciprocates or, in the case of a rotor, rotates.
